(19) United States
(12) Patent Application Publication
(10) Pub. No.: US 2012/0241672 A1
(43) Pub. Date: Sep. 27, 2012

(54) COMPOSITION COMPRISING A CERIUM AND/OR TERBIUM PHOSPHATE AND SODIUM, OF CORE/SHELL TYPE, PHOSPHOR RESULTING FROM THIS COMPOSITION AND METHODS FOR PREPARING SAME

(75) Inventors: Valérie Buissette, Paris (FR); Thierry Le-Mercier, Rosny Sous Bois (FR)

(73) Assignee: RHODIA OPERATIONS, AUBERVILLIERS (FR)

(21) Appl. No.: 13/387,898

(22) PCT Filed: Jul. 21, 2010
(86) PCT No.: PCT/EP10/60529

§ 371 Date: Jun. 14, 2012

(30) Foreign Application Priority Data
Jul. 29, 2009 (FR) 09 03731

(51) Int. Cl. C09K 11/81; B05D 3/02; B05D 5/06

(52) U.S. Cl. 252/301.4 P; 427/157

(57) ABSTRACT

The composition of the invention is of the type comprising particles formed by a mineral core and a shell that covers the mineral core uniformly, said shell being based on a phosphate of cerium and/or of terbium, optionally with lanthanum. The composition is characterized in that it contains sodium at a concentration of at most 7000 ppm. The phosphor of the invention is obtained by calcination of the composition at at least 1000 DEG C.

The present invention relates to a composition comprising a cerium and/or terbium phosphate and sodium, optionally with lanthanum, of the core/shell type, to a phosphor obtained from this composition and to methods of preparing them.

Mixed lanthanum cerium terbium phosphates, denoted hereafter by LaCeTb phosphates, are well known for their luminescence properties. They emit a bright green light when they are irradiated by certain high-energy radiation having wavelengths shorter than those in the visible range (UV or VUV radiation for lighting or display systems). Phosphors that exploit this property are commonly used on an industrial scale, for example in trichromatic fluorescent lamps, in backlighting systems for liquid crystal displays or in plasma systems.

These phosphors contain rare earths, the cost of which is high and also subject to large fluctuations. Reducing the cost of these phosphors therefore constitutes a major challenge.

In addition, due to the rarity of certain rare earths, such as terbium, it is sought to reduce the amount thereof in phosphors.

Apart from reducing the cost of phosphors, it is also sought to improve their methods of preparation.

In particular, wet processing methods are known for producing LaCeTb phosphates, such as that described in patent application EP 0 581 621. Such a method makes it possible to improve the particle size of the phosphates, with a narrow particle size distribution, leading to particularly efficient phosphors. The method described employs more particularly nitrates such as rare-earth salts and recommends the use of ammonium hydroxide as base, but this has the drawback that nitrogenous products are discharged. Consequently, although the method does result in efficient products, its implementation may be made more complicated so as to conform to the ever more stringent environmental legislation that proscribes or limits such discharges.

Admittedly, it is possible to use in particular strong bases other than ammonium hydroxide, such as alkali metal hydroxides, but these result in alkali metals being present in the phosphates, their presence being considered as liable to degrade the luminescence properties of the phosphors.

There is therefore presently a need for methods of preparation in which little or no nitrates or ammonium hydroxide are used and to do so without a negative impact on the luminescence properties of the products obtained.

To meet the challenges and requirements mentioned above, a first object of the invention is to provide lower-cost phosphors.

Another object of the invention is to devise a method of preparing phosphates that limits the discharge of nitrogenous products or even without discharging such products.

With this aim, the composition of the invention is of the type comprising particles consisting of a mineral core and a shell homogeneously covering said mineral core, said shell being based on a phosphate of a rare earth (Ln), Ln representing either at least one rare earth chosen from cerium and terbium, or lanthanum in combination with at least one of the two aforementioned rare earths, and this composition is characterized in that it contains sodium with a content of at most 7000 ppm.

Other features, details and advantages of the invention will become even more fully apparent on reading the following description and the various specific, but nonlimiting, examples intended to illustrate it.

It should also be pointed out that, in the rest of the description, unless otherwise indicated, in all the ranges or limits of values given, the values at the bounds are inclusive, the ranges or limits of values thus defined therefore covering any value at least equal to and greater than the lower bound and/or at most equal to or less than the upper bound.

It is also mentioned here, and in respect of the entire description, that the sodium content is measured using two techniques. The first is the X-ray fluorescence technique enabling sodium contents which are at least about 100 ppm to be measured. This technique will be used more particularly for phosphates or precursors or phosphors in which the sodium contents are the highest. The second technique is the ICP-AES (Inductively Coupled Plasma-Atomic Emission Spectroscopy) or the ICP-OES (Inductively Coupled Plasma-Optical Emission Spectroscopy) technique. This technique will be used more particularly here for precursors or phosphors in which the sodium contents are the lowest, especially for contents below about 100 ppm.

The term “rare earth” is understood in the rest of the description to mean elements of the group formed by scandium, yttrium and those elements of the periodic table having an atomic number between 57 and 71 inclusive.

The term “specific surface area” is understood to mean the BET specific surface area determined by krypton adsorption. The surface areas given in the present description were measured on an ASAP2010 instrument after degassing the powder for 8 h at 200° C.

As mentioned above, the invention relates to two types of product: phosphate-containing compositions, also called hereafter compositions or precursors; and phosphors obtained from these precursors. The phosphors themselves have luminescence properties sufficient for rendering them directly usable in the desired applications. The precursors do not have luminescence properties or they do possibly have luminescence properties but these are generally too low for use in these same applications.

These two types of product will now be described in more detail.

### Phosphate-Containing Compositions or Precursors

The phosphate-containing compositions of the invention are firstly characterized by their specific core/shell structure which is described below.

The mineral core is based on a material which may especially be a mineral oxide or a phosphate.

Among oxides, mention may in particular be made of zirconium oxide, zinc oxide, titanium oxide, magnesium oxide, aluminum oxide (alumina) and oxides of the rare earths. As rare-earth oxides, gadolinium oxide, yttrium oxide and cerium oxide may be even more particularly mentioned.

The oxides preferably chosen may be yttrium oxide, gadolinium oxide and alumina.

Among phosphates, mention may be made of the orthophosphates of one or more rare earths, one of them possibly acting as a dopant, such as lanthanum orthophosphate (LaPO₄), lanthanum cerium orthophosphate ((LaCe)PO₄), yttrium orthophosphate (YPO₄) and rare-earth or aluminum polyphosphates.

According to one particular embodiment, the material of the core is a lanthanum orthophosphate, a gadolinium orthophosphate or an yttrium orthophosphate.

Mention may also be made of alkaline-earth phosphates, such as Ca₂P₂O₇, zirconium phosphate ZrP₂O₇ and alkaline-earth hydroxyapatites.

Other mineral compounds such as vanadates, especially a rare-earth vanadate (YVO₄), germanates, silica, silicates, especially zinc or zirconium silicate, tungstates, molybdates, sulfates (BaSO₄), borates (YBO₃, GdBO₃), carbonates and titanates (such as BaTiO₃), zirconates, and alkaline-earth metal aluminates, optionally doped by a rare earth, such as barium and/or magnesium aluminates, for example MgAl₂O₄, BaAl₂O₄ or BaMgAl₁₀O₁₇, are furthermore suitable.

Finally, compounds derived from the above compounds may be suitable, such as mixed oxides, especially rare-earth oxides, for example mixed zirconium cerium oxides, mixed phosphates, especially mixed rare-earth phosphates, and phospho vanadates.

In addition, the material of the core may have particular optical properties, especially UV reflection properties.

The expression “the mineral core is based on” is understood to denote an assembly comprising at least 50%, preferably at least 70%, more preferably at least 80% or even 90% by weight of the material in question. According to one particular embodiment, the core may essentially consist of said material (namely in a content of at least 95% by weight, for example at least 98% or even at least 99% by weight) or even entirely consist of this material.

Several advantageous embodiments of the invention will now be described below.

According to a first embodiment, the core is made of a dense material, corresponding in fact to a generally well crystallized material or else to a material having a low specific surface area.

The expression “low specific surface area” is understood to mean a specific surface area of at most 5 m²/g, more particularly at most 2 m²/g, even more particularly at most 1 m²/g and especially at most 0.6 m²/g.

According to another embodiment, the core is based on a temperature-stable material. By this is meant a material which has a melting point at a high temperature, which does not degrade into a by-product which would be problematic for the application as a phosphor at this same temperature, and which remains crystalline, therefore not being transformed into an amorphous material, again at this same temperature. The high temperature intended here is a temperature at least above 900° C., preferably at least above 1000° C. and even more preferably at least 1200° C.

The third embodiment consists in using for the core a material that combines the features of the above two embodiments, therefore a temperature-stable material having a low specific surface area.

The fact of using a core according to at least one of the embodiments described above has a number of advantages. Firstly, the core/shell structure of the precursor is particularly well maintained in the phosphor that results therefrom, enabling a maximum cost advantage to be achieved.

Moreover, it has been found that the phosphors obtained from the precursors of the invention, in the manufacture of which a core according to at least one of the aforementioned embodiments was used, have photoluminescence efficiencies not only identical but in certain cases superior to those of a phosphor of the same composition but not having a core/shell structure.

The materials of the core may be densified, especially by using the known molten salt technique. This technique consists in bringing the material to be densified to a high temperature, for example at least 900° C., optionally in a reducing atmosphere, for example an argon/hydrogen mixture, in the presence of a fluxing agent, which may be chosen from chlorides (for example sodium chloride or sodium chloride), fluorides (for example lithium fluoride), borates (lithium borate), carbonates and boric acid.

The core may have a mean diameter of especially between 1 and 10 μm.

These diameters may be determined by SEM (scanning electron microscopy) with statistical counting of at least 150 particles.

The dimensions of the core, and likewise those of the shell that will be described below, may also be measured especially on transmission electron micrographs of sections of phosphates/precursors of the invention.

The other structural feature of the compositions/precursors of the invention is the shell.

This shell covers the core homogeneously over a given thickness which, according to one particular embodiment of the invention, is equal to or greater than 300 nm. The term “homogeneous layer” is understood to mean a continuous layer completely covering the core and having a thickness which is preferably never less than a given value, for example 300 nm in the case of a shell according to the abovementioned particular embodiment. Such homogeneity is especially visible on scanning electron micrographs. X-ray diffraction (XRD) measurements furthermore demonstrate the presence of two separate compositions, that of the core and that of the shell.

The thickness of the shell may be more particularly at least 500 nm. It may also be equal to or less than 2000 nm (2 μm) and more particularly equal to or less than 1000 nm.

The shell is based on a specific rare-earth (Ln) phosphate that will be described in greater detail below.

The phosphate of the shell is essentially (as the presence of other residual phosphate-containing species is possible), and preferably completely, of the orthophosphate type.

The phosphate of the shell is a phosphate of cerium or terbium or else a combination of these two rare earths. It may also be a lanthanum phosphate in combination with at least one of these two aforementioned rare earths, and it may also be most particularly a lanthanum cerium terbium phosphate.

The respective proportions of these various rare earths may vary widely, and more particularly within the ranges of values to be given below. Thus, the phosphate of the shell essentially comprises a product that may satisfy the following general formula (I):

LaₓCe_{y}Tb_{z}PO₄ (1)

in which the sum x+y+z is equal to 1 and at least one of y and z is different from 0.

In the above formula (I), x may more particularly be between 0.2 and 0.98 and even more particularly between 0.4 and 0.95.

If at least one of x and y is different from 0 in the formula (I), preferably z is at most 0.5 and z may be between 0.05 and 0.2 and more particularly between 0.1 and 0.2.

If y and z are both different from 0, x may be between 0.2 and 0.7 and more particularly between 0.3 and 0.6.

If z is equal to 0, y may be more particularly between 0.02 and 0.5 and even more particularly between 0.05 and 0.25.

If y is equal to 0, z may more particularly be between 0.05 and 0.6 and even more particularly between 0.08 and 0.3.

If x is equal to 0, z may more particularly be between 0.1 and 0.4.

The following more particular compositions may be mentioned purely as examples:

La_{0.44}Ce_{0.43}Tb_{0.13}PO₄

La_{0.57}Ce_{0.29}Tb_{0.14}PO₄

La_{0.94}Ce_{0.06}PO₄

Ce_{0.67}Tb_{0.33}PO₄.

The presence of the other residual phosphate-containing species mentioned above may mean that the Ln (all the rare earths)/PO₄ molar ratio could be less than 1 for the overall phosphate of the shell.

The phosphate of the shell may comprise other elements conventionally acting especially as a promoter in respect of the luminescence properties or as a stabilizer for stabilizing the oxidation state of the elements cerium and terbium. As examples of other such elements, mention may more particularly be made of boron and other rare earths, such as scandium, yttrium, lutetium and gadolinium. When lanthanum is present, the aforementioned rare earths may be more particularly present as substitution for this element. These promoter or stabilizer elements are present in an amount of generally at most 1% by weight of element relative to the total weight of phosphate of the shell in the case of boron and generally at most 30% in the case of the other elements mentioned above.

The phosphate of the shell may have three types of crystal structure depending on the embodiment of the invention. These crystal structures may be determined by XRD.

According to a first embodiment, the phosphate of the shell may firstly have a monazite crystal structure.

According to another embodiment; the phosphate may have a rhabdophane structure.

Finally, according to a third embodiment, the phosphate of the shell may have a mixed rhabdophane/monazite structure.

The monazite structure corresponds to those compositions which, after their preparation, have undergone a heat treatment at a temperature of generally at least 600° C.

The rhabdophane structure corresponds to those compositions which, after their preparation, have either not undergone a heat treatment or have undergone a heat treatment at a temperature generally not exceeding 400° C.

The phosphate of the shell for the compositions that have not undergone a heat treatment is generally hydrated. However, simple drying operations, carried out for example between 60 and 100° C., are sufficient to remove most of this residual water and to result in a substantially anhydrous rare-earth phosphate, the minor amounts of water remaining being removed by calcination carried out at higher temperatures, above about 400° C.

The mixed rhabdophane/monazite structure corresponds to those compositions which have undergone a heat treatment at a temperature of at least 400° C., possibly up to a temperature of below 600° C., which may be between 400° C. and 500° C.

According to a preferred embodiment, the phosphates of the shell are pure phases, that is to say the XRD diffractograms reveal just a single monazite phase or rhabdophane phase depending on the embodiment. However, the phosphate may also not be a pure phase, and in this case the XRD diffractogram of the products shows the presence of very minor residual phases.

One important feature of the compositions of the invention is the fact that they contain sodium.

According to preferred embodiments of the invention, this sodium is present mostly (by this is meant at least 50% of the sodium) in the shell, preferably essentially (by this is meant at least 80% of the sodium) in the shell or even entirely in the shell.

It may be thought that the sodium, when it is in the shell, is not present therein simply as a mixture with the other constituents of the phosphate of the shell but forms a chemical bond with one or more constituent chemical elements of the phosphate. The chemical nature of this bond may be demonstrated by the fact that simple washing, with pure water at atmospheric pressure, does not remove the sodium present in the phosphate of the shell.

As mentioned above, the maximum sodium content is at most 7000 ppm, more particularly at most 6000 ppm and even more particularly at most 5000 ppm. This content is expressed, here and throughout the description, as the mass of sodium element relative to the total mass of the composition.

Even more particularly, this sodium content of the composition may depend on the embodiments described above, i.e. on the crystal structure of the phosphate of the shell.

Thus, if the phosphate of the shell has a monazite structure, this content may more particularly be at most 4000 ppm.

In the case of a phosphate of the shell having a rhabdophane or mixed rhabdophane/monazite structure, the sodium content may be higher than that in the preceding case. It may be even more particularly at most 5000 ppm.

The minimum sodium content is not critical. This may correspond to the minimum value detectable by the analysis technique used to measure the sodium content. However, generally this minimum content is at least 300 ppm whatever in particular the crystal structure of the phosphate of the shell.

This content may more particularly be at least 1000 ppm and may be even more particularly at least 1200 ppm.

According to one particular embodiment, the sodium content may be between 1400 and 2500 ppm.

According to one particular embodiment of the invention, the composition contains, as alkali metal element, only sodium.

The compositions/precursors of the invention consist of particles which have a mean diameter of preferably between 1.5 μm and 15 μm. This diameter may more particularly be between 3 μm and 10 μm and even more particularly between 4 μm and 8 μm.

The mean diameter referred to is the volume average of the diameters of a population of particles.

The particle sizes given here, and for the rest of the description, are measured by the technique of laser particle size analysis using, for example, a Malvern laser particle size analyzer on a sample of particles dispersed in water subjected to ultrasound (130 W) for 1 minute 30 seconds.

Furthermore, the particles preferably have a low dispersion index, typically at most 0.7, more particularly at most 0.6 and even more particularly at most 0.5.

The term “dispersion index” for a population of particles is understood to mean, in the context of the present description, the ratio I as defined below:

I=(D₈₄−D₁₆)/2D₅₀,

where: D₈₄ is the diameter of the particles for which 84% of the particles have a diameter below D₈₄;
D₁₆ is the diameter of the particles for which 16% of the particles have a diameter below D₁₆; and
D₅₀ is the mean diameter of the particles, for which diameter 50% of the particles have a diameter below D₅₀.

Although the compositions or precursors according to the invention have luminescence properties at wavelengths that vary according to the composition of the product and after exposure to radiation at a given wavelength (for example at a wavelength of about 540 nm, i.e. in the green, after exposure to radiation of 254 nm wavelength in the case of lanthanum cerium terbium phosphates), it is also possible, and even necessary, for these luminescence properties to be further improved by carrying out post-treatments on the products, so as to obtain a true phosphor that can be used directly as such in the desired application.

It will be understood that the boundary between a simple rare-earth phosphate and an actual phosphor remains arbitrary and depends on just the luminescence threshold above which it is considered that a product can be used directly and acceptably by a user.

In the present case, and quite generally, compositions according to the invention that have not been subjected to heat treatments above about 900° C. may be considered and identified as phosphor precursors since these products generally have luminescence properties that may be judged as not meeting the minimum brightness criterion for commercial phosphors that can be used directly as such, without any subsequent transformation. Conversely, compositions which, after having been subjected to any appropriate treatments, develop suitable brightnesses, sufficient for being used directly by an applicator, for example in lamps, television screens or light-emitting diodes, may be termed phosphors.

The phosphors according to the invention are described below.

### Phosphors

The phosphors according to the invention are of the type comprising particles consisting of a mineral core and a shell homogeneously covering the mineral core, said shell being based on a phosphate of a rare earth (Ln), Ln representing either at least one rare earth chosen from cerium and terbium, or lanthanum in combination with at least one of the two aforementioned rare earths, and they are characterized in that the rare-earth phosphate of the shell has a monazite crystal structure and in that they contain sodium, the sodium content being at most 350 ppm.

The phosphors of the invention have features that are common to those of the compositions or precursors that have just been described.

Thus, all that was described above on the subject of these precursors applies likewise here in the description of the phosphors according to the invention as regards the features relating to the structure, consisting of the mineral core and the homogeneous shell, to the nature of the mineral core and to the thickness of the shell, which here too may be equal to or greater than 300 nm, and as regards the particle size features, the particles of the phosphors thus possibly having a mean diameter between 1.5 μm and 15 μm.

The rare-earth (Ln) phosphate of the shell also has, in orthophosphate form, a composition substantially identical to that of the phosphate of the shell of the precursors. The relative proportions of lanthanum, cerium and terbium that were given above for the precursors also apply here. Likewise, the phosphate of the shell may comprise the promoter or stabilizer elements mentioned above and in the proportions indicated.

The phosphate of the shell of the phosphors has a monazite crystal structure. As in the case of the phosphors, this crystal structure may also be demonstrated by XRD. According to a preferred embodiment, this shell phosphate may be a pure phase, that is to say the XRD diffractograms reveal just a single monazite phase. However, this phosphate may also not be a pure phase, and in this case the XRD diffractograms of the products show the presence of very minor residual phases.

The phosphor of the invention contains sodium, with the maximum content given above. This content is expressed, here too, by weight of sodium element relative to the total weight of the phosphor. It will also be noted that the sodium content may more particularly be at most 250 ppm and even more particularly at most 100 ppm.

According to preferred embodiments of the invention, and as in the case of the compositions/precursors described above, this sodium is present mostly (by this is meant at least 50% of the sodium) in the shell, preferably essentially (by this is meant at least 80% of the sodium) in the shell or even entirely in the shell.

The minimum sodium content is not critical. Here too, as in the case of the compositions, this may correspond to the minimum value detectable by the analysis technique used to measure the sodium content. However, generally this minimum content is at least 10 ppm, more particularly at least 40 ppm and even more particularly at least 50 ppm.

According to one particular embodiment, the phosphors do not contain any element other than sodium as alkali metal element.

The particles constituting the phosphors of the invention may be of substantially spherical shape. These particles are dense.

The methods of preparing the precursors and the phosphors of the invention will now be described.

### Method of Preparing Compositions or Precursors

The method of preparing the compositions/precursors is characterized in that it comprises the following steps:
a first solution containing chlorides of one or more rare earths (Ln) is introduced continuously into a second solution that contains particles of the mineral core and phosphate ions and has an initial pH of less than 2;
while introducing the first solution into the second, the pH of the mixture thus obtained is maintained at a constant value of less than 2, thereby obtaining a precipitate, the operation of setting the pH for the second solution at less than 2 for the first step or the operation of maintaining the pH for the second step, or both these operations, being carried out at least partly using sodium hydroxide;
the precipitate thus obtained is recovered; and
   either, in the case of preparing a composition in which the rare-earth phosphate of the shell has a monazite crystal structure, said phosphate is calcined at a temperature of at least 600° C.;
   or, in the case of preparing a composition in which the rare-earth phosphate of the shell has a rhabdophane or mixed rhabdophane/monazite crystal structure, said phosphate is calcined, possibly, at a temperature below 600° C.; and
the product obtained is redispersed in hot water and then separated from the liquid medium.

The various steps of the method will now be detailed.

According to the invention, a rare-earth (Ln) phosphate is precipitated directly, at a maintained pH, by reacting a first solution containing chlorides of one or more rare earths (Ln), these elements then being present in the required proportions for obtaining the product having the desired composition, with a second solution containing phosphate ions and particles of the mineral core, these particles being maintained in the dispersed state in said solution.

A core is chosen in the form of particles having a particle size appropriate to that of the composition intended to be prepared. Thus, a core having a mean diameter especially between 1 and 10 μm and having a dispersion index of at most 0.7 or at most 0.6 may in particular be used. Preferably, the particles have an isotropic, advantageously substantially spherical, morphology.

According to a first important feature of the method, a certain order of introducing the reactants must be respected and, more precisely still, the solution of chlorides of the one or more rare earths must be introduced progressively and continually into the solution containing the phosphate ions.

According to a second important feature of the method according to the invention, the initial pH of the solution containing the phosphate ions must be less than 2 and preferably between 1 and 2.

According to a third feature, the pH of the precipitation medium must then be maintained at a pH value of less than 2 and Preferably between 1 and 2

The term “maintained pH” is understood to mean that the pH of the precipitation medium is maintained at a certain, constant or approximately constant, value by addition of a basic compound to the solution containing the phosphate ions, this addition being simultaneous with the introduction into said solution of the solution containing the rare-earth chlorides. The pH of the mixture will thus vary by at most 0.5 pH units about the setpoint value set, and more preferably by at most 0.1 pH units about this value. The setpoint value set will advantageously correspond to the initial pH (less than 2) of the solution containing the phosphate ions.

The precipitation is preferably carried out in aqueous medium at a temperature which is not critical and is advantageously between room temperature (15° C.-25° C.) and 100° C. The precipitation takes place while the reaction mixture is being stirred.

The concentration of the rare-earth chlorides in the first solution may vary widely. Thus, the total rare-earth concentration may be between 0.01 mol/liter and 3 mol/liter.

Finally, it should be noted that the rare-earth chloride solution may further contain other metal salts, especially chlorides, such as for example salts of the promoter or stabilizer elements described above, i.e. boron and other rare earths.

The phosphate ions intended to react with the rare-earth chloride solution may be supplied by pure or dissolved compounds, such as for example phosphoric acid, alkali metal phosphates or phosphates of other metallic elements giving, with the anions associated with the rare earths, a soluble compound.

The phosphate ions are present in an amount such that, between the two solutions, there is a PO₄/Ln molar ratio of greater than 1 and advantageously between 1.1 and 3.

As emphasized earlier in the description, the solution containing the phosphate ions and the particles of the mineral core must have initially (i.e. before the rare-earth chloride solution starts to be introduced) a pH of less than 2 and preferably between 1 and 2. Therefore, if the solution used does not naturally have such a pH, this is brought to the desired suitable value either by addition of a basic compound or by addition of an acid (for example hydrochloric acid in the case of an initial solution having too high a pH).

Thereafter, as the solution containing the rare-earth chloride or chlorides is being introduced, the pH of the precipitation medium progressively decreases. Therefore, according to one of the essential features of the method according to the invention, for the purpose of maintaining the pH of the precipitation medium at the constant desired working value, which must be less than 2 and preferably between 1 and 2, a basic compound is introduced simultaneously into this medium.

According to another feature of the method of the invention, the basic compound used, either for bringing the initial pH of the second solution containing the phosphate ions to a value below 2 or for maintaining the pH during precipitation, is, at least partly, sodium hydroxide. The expression “at least partly” is understood to mean that it is possible to use a mixture of basic compounds, at least one of which is sodium hydroxide. The other basic compound may for example be ammonium hydroxide. According to a preferred embodiment, a basic compound which is just sodium hydroxide is used, and according to another even more preferable embodiment sodium hydroxide is used alone and for both the aforementioned operations, i.e. both for bringing the pH of the second solution to the suitable value and for maintaining the precipitation pH. In these two preferred embodiments, the discharge of nitrogenous products, which could arise from a basic compound such as ammonium hydroxide, is lessened or eliminated.

What is obtained directly after the precipitation step is a rare-earth (Ln) phosphate deposited as shell on the mineral core particles, possibly with other elements having been added. The overall concentration of rare earths in the final precipitation medium is then advantageously greater than 0.25 mol/liter.

After the precipitation, a maturation operation may optionally be carried out by maintaining the reaction mixture obtained above at a temperature lying within the same temperature range as that within which the precipitation took place and for a time which may for example be between a quarter of an hour and one hour.

The precipitate may be recovered by any means known per se, in particular by simple filtration. Specifically, under the conditions of the method according to the invention, a compound comprising a filterable nongelatinous rare-earth phosphate is precipitated.

The product recovered is then washed, for example with water, and then dried.

The product may then be subjected to a calcination or heat treatment.

This calcination may be optionally carried out and at various temperatures depending on the structure of the phosphate intended to be obtained.

The duration of calcination is generally shorter the higher the temperature. Solely by way of example, this duration may be between 1 and 3 hours.

The heat treatment is generally carried out in air.

In general, the calcination temperature is at most about 400° C. in the case of a product in which the phosphate of the shell has the rhabdophane structure, this structure also being that of the uncalcined product resulting from the precipitation. In the case of a product in which the phosphate of the shell has a mixed rhabdophane/monazite structure, the calcination temperature is generally at least 400° C. and may be up to, but below, 600° C. It may be between 400° C. and 500° C.

To obtain a precursor in which the phosphate of the shell has a monazite structure, the calcination temperature is at least 600° C. and may be between about 700° C. and a temperature below 1000° C., more particularly at most about 900° C.

According to another important feature of the invention, the product after calcination or even precipitation in the case of no heat treatment is then redispersed in hot water.

This redispersing operation is carried out by introducing the solid product into the water with stirring. The suspension thus obtained is kept stirred for a period which may be between about 1 and 6 hours, more particularly between about 1 and 3 hours.

The temperature of the water may be at least 30° C., more particularly at least 60° C., and may be between about 30° C. and 90° C., preferably between 60° C. and 90° C., at atmospheric pressure. It is possible to carry out this operation under pressure, for example in an autoclave, at a temperature which may then be between 100° C. and 200° C., more particularly between 100° C. and 150° C.

In a final step, the solid is separated from the liquid medium by any means known per se, for example by simple filtration. The redispersing step may optionally be repeated, one or more times, under the conditions described above, possibly at a different temperature from that at which the first redispersing step was carried out.

The separated product may be washed, for example with water, and may be dried.

### Method of Preparing Phosphors

The phosphors of the invention are obtained by calcining the compositions or precursors, such as those described above, or compositions or precursors obtained by the method as also described above, at a temperature of at least 1000° C. This temperature may be between about 1000° C. and 1300° C.

The compositions or precursors are converted to effective phosphors by this treatment.

Although, as indicated above, the precursors may themselves have intrinsic luminescence properties, these properties are generally insufficient for the intended applications and are greatly improved by the calcination treatment.

The calcination may be carried out in air or in an inert gas, but also, and preferably, in a reducing atmosphere (for example H₂, N₂/H₂ or Ar/H₂) so as, in the latter case, to convert all the Ce and Tb species to their +III oxidation state.

As is known, the calcination may be carried out in the presence of a flux or fluxing agent such as, for example, lithium fluoride, lithium tetraborate, lithium chloride, lithium carbonate, lithium phosphate, ammonium chloride, boron oxide, boric acid and ammonium phosphates, as well as mixtures thereof.

If a flux is used, a phosphor is obtained that has luminescence properties which in general are at least equivalent to those of known phosphors. The most important advantage here of the invention is that the phosphors stem from precursors which themselves result from a method that discharges fewer nitrogenous products than the known methods, or even none such products.

It is also possible to carry out the calcination in the absence of any flux, and therefore without premixing the fluxing agent with the phosphate, thereby simplifying the method and helping to reduce the content of impurities present in the phosphor. In addition, this thus avoids using products that may contain nitrogen or that have to be processed according to strict safety standards on account of their possible toxicity, this being the case for a large number of the abovementioned fluxing agents.

After treatment, the particles are advantageously washed so as to obtain a phosphor as pure as possible and in a deagglomerated or slightly agglomerated state.

In the latter case, it is possible to deagglomerate the phosphor by subjecting it to a mild deagglomeration treatment.

It has been found that the phosphors of the invention resulting from flux-free calcination may have, compared with the phosphors of the prior art obtained under the same calcination conditions, an improved luminescence yield. Without wishing to be tied to any one theory, this better yield is thought to be the consequence of better crystallization of the phosphors of the invention, this better crystallization also being the consequence of better crystallization of the compositions/precursors.

The aforementioned heat treatments make it possible to obtain phosphors that retain a core/shell structure and a particle size distribution that are very close to those of the particles of the precursor.

Furthermore, the heat treatment may be carried out without inducing substantial diffusion of the Ce and Tb species from the external phosphor layer into the core.

According to one conceivable specific embodiment of the invention, it is possible to carry out in one and the same step the heat treatment described for preparing the precursor and the calcination for converting the precursor into a phosphor. In this case, the phosphor is obtained directly without stopping at the precursor stage.

The phosphors of the invention have intense luminescence properties for electromagnetic excitations corresponding to the various absorption fields of the product.

Thus, the phosphors of the invention based on cerium and terbium may be used in lighting or display systems having an excitation source in the UV (200-280 nm) range, for example around 254 nm, notably, in particular, trichromatic mercury vapor lamps, especially of the tubular type, and lamps for the backlighting of liquid-crystal systems in tubular or planar form (LCD backlighting). They have a high brightness under UV excitation, and an absence of luminescence loss following a thermal post-treatment. Their luminescence is in particular stable under UV at relatively high temperatures between room temperature and 300° C.

The phosphors of the invention based on terbium and lanthanum or on lanthanum, cerium and terbium are also good candidates as green phosphors for VUV (or “plasma”) excitation systems, such as for example for plasma displays and mercury-free trichromatic lamps, especially xenon excitation lamps (whether tubular or planar). The phosphors of the invention have a strong green emission under VUV excitation (for example around 147 nm and 172 nm). The phosphors are stable under VUV excitation.

The phosphors of the invention may also be used as green phosphors in LED (light-emitting diode) excitation devices. They may be especially used in systems that can be excited in the near UV.

They may also be used in UV excitation marking systems.

The phosphors of the invention may be applied in lamp and display systems using well-known techniques, for example screen printing, spraying, electrophoresis or sedimentation.

They may also be dispersed in organic matrices (for example matrices made of plastics or polymers that are transparent under UV, etc.), inorganic (for example silica) matrices or organic-inorganic hybrid matrices.

The invention also relates, according to another aspect, to the luminescent devices of the aforementioned type that comprise, as green luminescence source, the phosphors as described above or the phosphors obtained from the method as also described above.

Examples will now be given.

In the following examples, the products prepared have been characterized in terms of particle size, morphology, composition and properties using the following methods.

### Sodium Content

The sodium content was determined, as indicated above, by two measurement techniques. For the X-ray fluorescence technique, this involved a semi-quantitative analysis carried out on the powder of the product as such. The instrument used was a PANalytical MagiX PRO-PW 2540 X-ray fluorescence spectrometer. The ICP-AES (or ICP-OES) technique was carried out with quantitative dosing by dosed additions using a Jobin Yvon ULTIMA instrument. The specimens were subjected beforehand to a mineralization (or digestion) treatment in a microwave-assisted nitric/perchloric medium in a closed reactor (MARS-CEM system).

### Luminescence

The photoluminescence (PL) yield was measured on the products in powder form by comparing the areas under the emission spectrum curve between 450 nm and 750 nm recorded by a spectrophotometer under 254 nm excitation and assigning a 100% value to the area obtained for the comparative product.

### Particle Size Measurement

The particle diameters were determined using a Coulter laser particle size analyzer (Malvern 2000) on a sample of particles dispersed in water and subjected to ultrasound (130 W) for 1 minute 30 seconds.

### Electron Microscopy

Micrographs were obtained using transmission electron microscopy on a microtomed section of the particles using a high-resolution JEOL 2010 FEG TEM microscope. The spatial resolution of the instrument for the chemical composition measurements by EDS (energy dispersion spectroscopy) was <2 nm. By correlating the observed morphologies and the measured chemical compositions, it was possible to demonstrate the core/shell structure and to measure the thickness of the shell on the micrographs.

The chemical composition measurements were also carried out by EDS on micrographs produced by HAADF-STEM. The measurement corresponded to an average taken over at least two spectra.

### X-Ray Diffraction

The X-ray diffractograms were produced using the K_{α} line with copper as anticathode according to the Bragg-Brentano method. The resolution was chosen so as to be sufficient to separate the LaPO₄:Ce,Tb line from the LaPO₄ line, preferably this resolution was Δ(2θ)<0.02°.

### COMPARATIVE EXAMPLE 1

This example relates to the preparation of a precursor based on a rare-earth phosphate according to the prior art.

Added over 1 hour to 500 ml of a phosphoric acid (H₃PO₄) solution, brought beforehand to pH 1.4 by addition of ammonium hydroxide and heated to 60° C., were 500 ml of a solution of rare-earth nitrates having an overall concentration of 1.5 mol/l and made up as follows: 0.855 mol/l of lanthanum nitrate; 0.435 mol/l of cerium nitrate; and 0.21 mol/l of terbium nitrate. The phosphate/rare-earth molar ratio was 1.15. The pH during the precipitation was adjusted to 1.3 by addition of ammonium hydroxide.

After the precipitation step, the mixture was again held for 1 h at 60° C. The resulting precipitate was then recovered by filtration, washed with water and then dried in air at 60° C., before being subjected to a heat treatment at 900° C. in air for 2 h. At the end of this step, a precursor with the composition (La_{0.57}Ce_{0.29}Tb_{0.14})PO₄ was obtained.

The particle size (D₅₀) was 6.7 μm, with a dispersion index of 0.4.

### EXAMPLE 2

This example describes a precursor according to the invention comprising an LaPO₄ core and a shell based on a phosphate of the (LaCeTb)PO₄ type.

### Synthesis of the Core

Added over 1 hour to 500 ml of a phosphoric acid (H₃PO₄) solution (1.725 mol/l), brought beforehand to pH 1.9 by addition of ammonium hydroxide and heated to 60° C., were 500 ml of a lanthanum nitrate solution (1.5 mol/l). The pH during precipitation was adjusted to 1.9 by addition of ammonium hydroxide.

After the precipitation step, the reaction mixture was again held for 1 h at 60° C. The precipitate was then recovered by filtration, washed with water and then dried at 60° C. in air. The powder obtained was then subjected to a heat treatment at 900° C. in air.

Finally, the powder was, subjected to a densification treatment using the molten salts technique. The powder was thus calcined for 2 h in the presence of 1% by weight of LiF, at 1100° C. and in a reducing atmosphere (Ar/H₂). A rare-earth phosphate of monazite structure with a specific surface area of 0.5 m²/g was then obtained. The mean diameter of the core thus obtained, measured by SEM, was 3.2 μm.

### Synthesis of an LaPO₄/LaCeTbPO₄ Core/Shell Composition/Precursor

A 1.3 mol/l rare-earth chloride solution was produced in a 1-liter beaker from 446.4 ml of a 1.387 mol/l LaCl₃ solution, 185.9 ml of a 1.551 mol/l CeCl₃ solution, 73.6 ml of a 2.177 mol/l TbCl₃ solution and 115.6 ml of deionized water, i.e. a total of 1.07 mol of rare-earth chlorides, having the composition (La_{0.58}Ce_{0.27}Tb_{0.15})Cl₃.

Introduced into a 2.5-liter reactor were 0.41 l of deionized water to which 83 g of Normapur 85% H₃PO₄ and then about 6 mol/l of sodium hydroxide NaOH were added so as to attain a pH of 1.5. The solution was heated to 60° C.

Next, 93.6 g of the lanthanum-phosphate-based core prepared above were added to the stock thus prepared. The pH was adjusted to 1.5 with 6 mol/l sodium hydroxide. 461 ml of the rare-earth chloride solution prepared beforehand were added with stirring to the mixture over 1 hour at a temperature of 60° C. with the pH adjusted to 1.5. The mixture obtained was matured for 1 h at 60° C.

At the end of the maturing step, the solution was left to cool down to 30° C. and the product recovered. This was then filtered over sintered glass and washed with 2 volumes of water before being dried and calcined for 2 h at 700° C. in air.

After calcination, the product obtained was redispersed in 80° C. water for 3 h, then washed and filtered and finally dried.

A rare-earth phosphate of monazite structure, having two monazite crystal phases of different compositions, namely LaPO₄ and (La,Ce,Tb)PO₄, was then obtained.

This precursor according to the invention contained 1450 ppm of sodium.

The mean particle size (D₅₀) was 7.3 μm, with a dispersion index of 0.3.

A TEM micrograph was taken of the resin-coated product prepared by ultramicrotomy (thickness ˜100 nm) and placed on a membrane having holes. The particles were seen in section. A section through a particle, the core of which was spherical and surrounded by a shell with an average thickness of 0.8 μm, was observed in this micrograph.

### COMPARATIVE EXAMPLE 3

This example relates to a phosphor obtained from the precursor of comparative example 1.

The precursor powder obtained in this example was calcined for 2 h in an Ar/H₂ (5% hydrogen) atmosphere at 1100° C. After this step, an LAP phosphor was obtained. The mean particle size (D₅₀) was 6.8 μm, with a dispersion index of 0.4.

The composition of the product was (La_{0.57}Ce_{0.29}Tb_{0.14})PO₄, i.e. 15.5% by weight of terbium oxide (Tb₄O₇) relative to the sum of the rare-earth oxides.

The efficiency (PL) of the phosphor thus obtained was measured as described above and normalized to 100%.

### EXAMPLE 4

This example relates to an LaPO₄/(LaCeTb)PO₄ core/shell phosphor according to the invention.

The precursor powder obtained in Example 2 was calcined for 2 h at 1100° C. in an Ar/H₂ (5% hydrogen) atmosphere. After this step, a core/shell phosphor was obtained. The mean particle size (D₅₀) was 7.3 μm, with a dispersion index of 0.4.

The phosphor contained 90 ppm sodium.

The table below gives the photoluminescence (PL) yields of the products obtained.

| Example | Mass of terbium used | PL |
|---|---|---|
| Example 3 | 107 g of Tb₄O₇/kg of phosphor | 100 |
| Example 4 | 71 g of Tb₄O₇/kg of phosphor | 99 |

This table shows that the phosphor of the invention has a photoluminescence that is substantially equal to that of the comparative product. By contrast, the terbium content in the product of the invention is distinctly lower, by approximately 34%. The 1% difference in photoluminescence is only of little importance in luminescence applications of the product compared to the saving in terbium made.

1. A composition comprising particles consisting of a mineral core and a shell homogeneously covering said mineral core, said shell being based on a phosphate of a rare earth (Ln), Ln representing either at least one rare earth chosen from cerium and terbium, or lanthanum in combination with at least one of the two aforementioned rare earths, wherein said composition contains sodium with a content of at most 7000 ppm.

2. The composition as claimed in claim 1, wherein the mineral core of the particles is based on a phosphate or a mineral oxide.

3. The composition as claimed in claim 1, wherein the shell has a thickness equal to or greater than 300 nm.

4. The composition as claimed in claim 1, wherein the particles have a mean diameter of between 1.5 μm and 15 μm.

5. The composition as claimed in claim 1, wherein the rare-earth phosphate of the shell is:
either of rhabdophane or mixed rhabdophane/monazite crystal structure; or
of monazite crystal structure,
wherein, when the rare-earth phosphate has a monazite crystal structure the sodium content of the composition is at most 4000 ppm.

6. The composition as claimed in claim 1, wherein the sodium content is at least 300 ppm.

7. The composition as claimed in claim 1, comprising a compound of the formula (1):
LaₓCe_{y}Tb_{z}PO₄ (1)
in which the sum x+y+z is equal to 1 and at least one of y and z is different from 0, in which x may be between 0.2 and 0.98.

8. A phosphor comprising particles consisting of a mineral core and a shell homogeneously covering the mineral core, said shell being based on a phosphate of a rare earth (Ln), Ln representing either at least one rare earth chosen from cerium and terbium, or lanthanum in combination with at least one of the two aforementioned rare earths, the rare-earth phosphate of the shell having a monazite crystal structure and the phosphor contains sodium, wherein the sodium content being at most 350 ppm.

9. The phosphor as claimed in claim 8, having a sodium content of at least 10 ppm.

10. The phosphor as claimed in claim 8, wherein the shell has a thickness equal to or greater than 300 nm.

11. The phosphor as claimed in claim 8, wherein the particles have a mean diameter of between 1.5 μm and 15 μm.

12. A method of preparing a composition as claimed in claim 1, comprising:
introducing a first solution containing chlorides of one or more rare earths (Ln) continuously into a second solution that contains particles of the mineral core and phosphate ions and has an initial pH of less than 2;
maintaining the pH of the mixture obtained while introducing the first solution into the second solution at a constant value of less than 2, thereby obtaining a precipitate, wherein the operation of setting the pH for the second solution at less than 2 for the first step or the operation of maintaining the pH for the second step, or both these operations, being carried out at least partly using sodium hydroxide;
recovering the precipitate thus obtained; and
either, in the case of preparing a composition in which the rare-earth phosphate of the shell has a monazite crystal structure, calcining said phosphate at a temperature of at least 600° C.;
or, in the case of preparing a composition in which the rare-earth phosphate of the shell has a rhabdophane or mixed rhabdophane/monazite crystal structure, calcining said phosphate; and
redispersing the product obtained in hot water and then separating the product from the liquid medium.

13. The method of preparing a phosphor as claimed in claim 8, said method comprising calcining a composition comprising particles consisting of a mineral core and a shell homogeneously covering said mineral core, said shell being based on a phosphate of a rare earth (Ln), Ln representing either at least one rare earth chosen from cerium and terbium, or lanthanum in combination with at least one of the two aforementioned rare earths, wherein said composition contains sodium with a content of at most 7000 ppm at a temperature of at least 1000° C.

14. The method as claimed in claim 13, wherein the calcination is carried out in a reducing atmosphere.

15. A device comprising a phosphor as claimed in claim 8, wherein said device is selected from the group consisting of plasma systems; mercury vapor lamps; lamps for backlighting liquid-crystal systems; mercury-free trichromatic lamps; LED excitation devices; and UV excitation marking systems.

16. A device comprising a phosphor obtained by the method as claimed in claim 13, wherein said device is selected from the group consisting of plasma systems; mercury vapor lamps; lamps for backlighting liquid-crystal systems; mercury-free trichromatic lamps; LED excitation devices; and UV excitation marking systems.

17. The method of preparing a phosphor as claimed in claim 8, said method comprising:
introducing a first solution containing chlorides of one or more rare earths (Ln) continuously into a second solution that contains particles of the mineral core and phosphate ions and has an initial pH of less than 2;
maintaining the pH of the mixture obtained while introducing the first solution into the second solution at a constant value of less than 2, thereby obtaining a precipitate, wherein the operation of setting the pH for the second solution at less than 2 for the first step or the operation of maintaining the pH for the second step, or both these operations, being carried out at least partly using sodium hydroxide;
recovering the precipitate thus obtained; and
either, in the case of preparing a composition in which the rare-earth phosphate of the shell has a monazite crystal structure, calcining said phosphate at a temperature of at least 1000° C.;
or, in the case of preparing a composition in which the rare-earth phosphate of the shell has a rhabdophane or mixed rhabdophane/monazite crystal structure, calcining said phosphate at a temperature of at least 1000° C.; and
redispersing the product obtained in hot water and then separating the product from the liquid medium.
